(19) United States
(12) Patent Application Publication
(10) Pub. No.: US 2021/0211030 A1
(43) Pub. Date: Jul. 8, 2021

(54) LINEAR VIBRATION MOTOR WITH S-SHAPED LEAF SPRINGS

(71) Applicant: LEADING TECHNOLOGY (DONGTAI) CO., LTD, Yancheng (CN)

(72) Inventors: Huajing LI, Yancheng (CN); Zhifeng LI, Yancheng (CN); Yuechong LIN, Yancheng (CN)

(73) Assignee: LEADING TECHNOLOGY (DONGTAI) CO., LTD, Yancheng (CN)

(21) Appl. No.: 17/058,668

(22) PCT Filed: Nov. 7, 2019
(86) PCT No.: PCT/CN2019/116223

§ 371 Date: Nov. 25, 2020

(30) Foreign Application Priority Data
May 20, 2019 (CN) 201910417477.2

(51) Int. Cl. H02K 33/02; H02K 33/18

(52) U.S. Cl. CPC H02K 33/02; B06B 1/045; H02K 33/18

(57) ABSTRACT

A linear vibration motor with S-shaped leaf springs includes an upper enclosure and a lower enclosure, wherein a mover assembly and a stator assembly correspondingly cooperating with the mover assembly are disposed in a space defined by the upper enclosure and the lower enclosure. The stator assembly is located below the mover assembly and is fixedly disposed on the lower enclosure. Two ends, in an X direction, of the mover assembly are elastically connected with the upper enclosure by the S-shaped leaf springs. Each S-shaped leaf spring includes elastic arms located on an upper layer and a lower layer and the elastic arms connected with the upper enclosure and a fixing part located on a middle layer and the fixing part connected with the mover assembly, the elastic arms are connected with the fixing part by first bent parts.

### CROSS-REFERENCE TO THE RELATED APPLICATIONS

This application is the national stage entry of International Application No. PCT/CN2019/116223, filed on Nov. 7, 2019, which is based upon and claims priority to Chinese Patent Application No. 201910417477.2, filed on May 20, 2019, the entire contents of which are incorporated herein by reference.

### TECHNICAL FIELD

The present disclosure relates to the technical field of motors and in particular to a linear vibration motor with S-shaped leaf springs.

### BACKGROUND

With the rapid development of electronic products and in particular a mobile terminal device such as a mobile phone and a tablet personal computer, these electronic devices basically adopt vibration generation apparatuses for preventing noise from electronic apparatuses from disturbing other persons. A traditional vibration generation apparatus adopts a rotor motor based on eccentric rotation, the rotor motor realizes mechanical vibration by virtue of the rotation of an eccentric vibrator, and during rotation of the eccentric vibrator, a commutator and an electric brush may generate mechanical friction, electric sparks and the like to affect the rotating speed of the eccentric vibrator and further affect the vibration effect of the apparatus, and therefore, most the vibration generation apparatuses adopt a linear motor with better performances.

The linear motor is also called a linear electric motor, a straight motor, a push rod motor and the like. The most common linear motor is in a flat plate type, a U-shaped groove type and a tubular type, is based on a technology for converting electric energy into mechanical energy of linear motion, is capable of making a moving element suspend by virtue of repulsive forces of magnets and also directly driving the moving element by virtue of a magnetic force, and does not need to be driven like a rotary motor which is driven by a driving mechanism such as a gear set, so that the linear motor can ensure that the moving element driven by the linear motor does high-acceleration/deceleration reciprocating motion. Due to such a characteristic, the linear motor can be applied to different technical fields of production so as to be used as a power source for driving or a technical content for providing positioning. In addition, with the rapid development and intense competition of industries such as semiconductors, electronics, photoelectricity, medical devices and automatic control, requirements of various fields on the linear motion performance of the motor are increased day by day, the motor is expected to have high speed, low noise, high positioning precision and the like, and therefore, the linear motor has been used to replace a mechanical motion mode such as a traditional servo motor in many application occasions.

However, some existing linear motors have problems such as insufficient elasticity, high cost as well as poor stability and reliability caused by certain defects on design of elastic elements, and thus, the vibration effect, stability and the like of the motor are affected.

### SUMMARY

The present disclosure provides a linear vibration motor with S-shaped leaf springs for solving problems of the above-mentioned existing linear motor.

In order to solve at least one of the above-mentioned technical problems, the present disclosure provides the following technical solutions:

a linear vibration motor with S-shaped leaf springs includes an upper enclosure and a lower enclosure, wherein a mover assembly and a stator assembly correspondingly cooperating with the mover assembly are disposed in a space defined by the upper enclosure and the lower enclosure, the stator assembly is located below the mover assembly and is fixedly disposed on the lower enclosure, and two ends, in an X direction, of the mover assembly are elastically connected with the upper enclosure by S-shaped leaf springs. Each S-shaped leaf spring includes elastic arms located on the upper layer and the lower layer and connected with the upper enclosure and a fixing part located on the middle layer and connected with the mover assembly, the two elastic arms are respectively connected with the fixing part by first bent parts, and a first slot is formed between each of the two elastic arms and the fixing part.

The present disclosure has the beneficial effects that the stator assembly interacts with the mover assembly so that the mover assembly bears a certain acting force. The mover assembly cooperates with the two S-shaped leaf springs to vibrate in the X direction. The S-shaped leaf springs are simple in structure, convenient to machine, low in production cost, stable in elastic coefficient and relatively high in elasticity; the elastic arms on the upper layer and the lower layer are connected with the upper enclosure, and the fixing part on the middle layer is connected with the mover assembly, so that the connection stability and reliability are high, the mass production capability and the process yield of the leaf springs are improved, and it is ensured that a mass stably vibrates; and the first bent parts and the first slots can release stresses of the leaf springs to prevent the leaf springs from deforming, so that the structural stability is high, the service life is long, and furthermore, the vibration effect and stability of the motor are improved.

In some implementation manners, the two first bent parts are connected with the fixing part by inclined parts, so that the elasticity of the leaf springs is improved.

In some implementation manners, the inclined parts are provided with adjusting slots by which it is convenient to control the widths of the elastic arms and adjust the frequencies of the leaf springs.

In some implementation manners, the ends, far away from the first bent parts, of the elastic arms are provided with first widened parts connected with the upper enclosure, so that it is convenient to connect the S-shaped leaf springs to the upper enclosure and improve the connection strength.

In some implementation manners, junctions of the first widened parts and the elastic arms are bent, and the first widened parts are parallel to the inner wall of the upper enclosure connected with the first widened parts, so that the elasticity is further improved, and it is more convenient to connect the S-shaped leaf springs to the upper enclosure.

In some implementation manners, the mover assembly includes a mass block, the mass block is provided with three or more permanent magnets arranged in the X direction, the permanent magnets are magnetized in the Z direction, and magnetization directions of the adjacent permanent magnets are opposite; and the stator assembly includes two or more coils arranged in the X direction, current directions of the adjacent coils are opposite, the coils are one less than the permanent magnets, the ends, far away from the adjacent coils, of the coils at the outer side correspond to one of the permanent magnets, the ends, close to each other, of the adjacent coils correspond to the same permanent magnet, and the coils may be connected with an external circuit by a flexible circuit board fixedly disposed on the lower enclosure.

In some implementation manners, the mass block is suspended in the upper enclosure by the two S-shaped leaf springs, and the middle parts of the two ends, in the X direction, of the mass block are each provided with a positioning part connected with the fixing part, so that it is convenient to connect the S-shaped leaf springs to the mass block.

In some implementation manners, the mass block is provided with a plurality of first through holes matched with the permanent magnets, so that it is convenient to mount the permanent magnets.

In some implementation manners, the bottom of the mass block is provided with an avoiding slot matched with the coils, and the avoiding slot communicates with the first through holes.

In some implementation manners, the two ends, in the X direction, of the mass block are each provided with two limiting buffer blocks, and two limiting buffer blocks correspondingly cooperate with two elastic arms.

In addition, all the technical solutions which are not particularly explained in the present disclosure can be implemented by adopting conventional means in the art.

### BRIEF DESCRIPTION OF THE DRAWINGS

In order to more clearly describe the specific implementation manners of the present disclosure or technical solutions in the prior art, accompanying drawings required for describing the specific implementation manners or the prior art will be briefly introduced below. Apparently, the accompanying drawings in the following description show only some embodiments of the present disclosure, and those of ordinary skill in the art can still derive other accompanying drawings from these accompanying drawings without creative efforts.

FIG. 1 is an exploded view of a linear vibration motor with S-shaped leaf springs, provided by an embodiment of the present disclosure;

FIG. 2 is a sectional view of a linear vibration motor with S-shaped leaf springs, provided by the embodiment of the present disclosure;

FIG. 3 is a schematic diagram of a three-dimensional structure of a linear vibration motor with S-shaped leaf springs with a housing removed, provided by the embodiment of the present disclosure;

FIG. 4 is a schematic diagram of a three-dimensional structure of an S-shaped leaf spring provided by the embodiment of the present disclosure; and

FIG. 5 is a front view of an S-shaped leaf spring provided by the embodiment of the present disclosure.

Description of symbols in accompanying drawings: upper enclosure 1; lower enclosure 2; mover assembly 3; mass block 31; positioning part 311; first through hole 312; avoiding slot 313; permanent magnet 32; limiting buffer block 33; stator assembly 4; coil 41; flexible circuit board 42; S-shaped leaf spring 5; elastic arm 51; fixing part 52; first bent part 53; first slot 54; inclined part 55; adjusting slot 551; and first widened part 56.

### DETAILED DESCRIPTION OF THE EMBODIMENTS

To make the objects, technical solutions and advantages of the present disclosure clearer, the present disclosure will be further described in detail in combination with the accompanying drawings and embodiments. It should be understood that the specific embodiments described herein are only a part of the embodiments of the present disclosure, and not all the embodiments, and the specific embodiments are only intended to explain the present disclosure, rather than to limit the present disclosure. Based on the embodiments in the present disclosure, all other embodiments obtained by those of ordinary skill in the art without creative efforts shall fall within the protection scope of the present disclosure.

In the description of the present disclosure, it should be explained that directional or positional relationships indicated by terms “center”, “upper”, “lower”, “left”, “right”, “vertical”, “horizontal”, “inside”, “outside”, “two ends”, “two sides” and the like are based on directional or positional relationships shown in the accompanying drawings and are only intended to facilitate describing the present disclosure and simplifying the description, rather than to indicate or imply that indicated elements have to be in specific directions or to be structured and operated in specific directions so as not to be understood as limitations on the present disclosure. In addition, terms “first”, “second”, “superior”, “ inferior”, “primary”, “secondary” and the like are for descriptive purposes only, can be simply used for more clearly distinguishing different components, but cannot be understood as indicating or implying the relative importance.

In the description of the present disclosure, it should be explained that terms “installation”, “connected” and “connection” should be understood in a broad sense unless otherwise specified and defined, for example, “connection” may be fixed connection or detachable connection or integrated connection, may be mechanical connection or electrical connection, may be direct connection or indirect connection through an intermediate medium, and may be internal connection of two elements. For those of ordinary skill in the art, specific meanings of the above terms in the present disclosure may be understood according to specific situations.

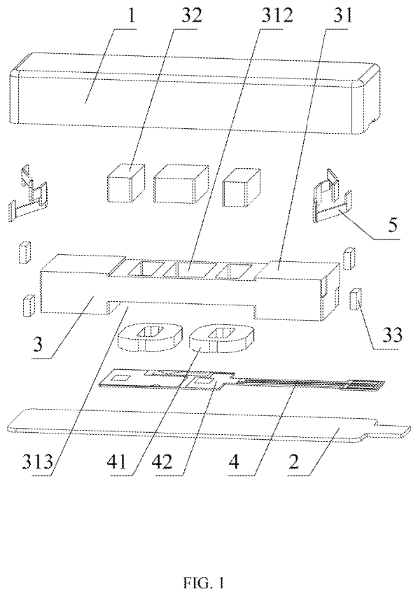

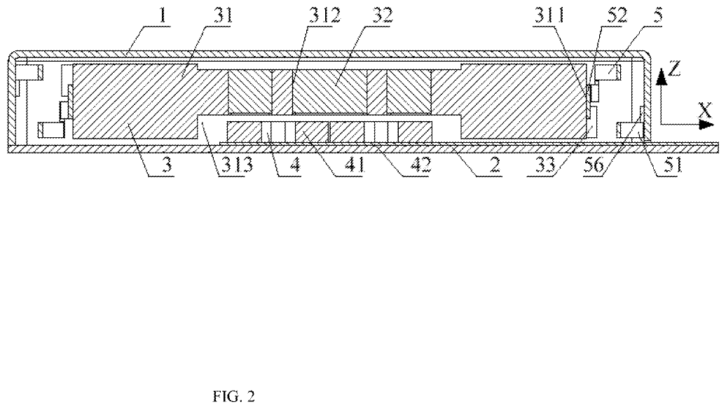

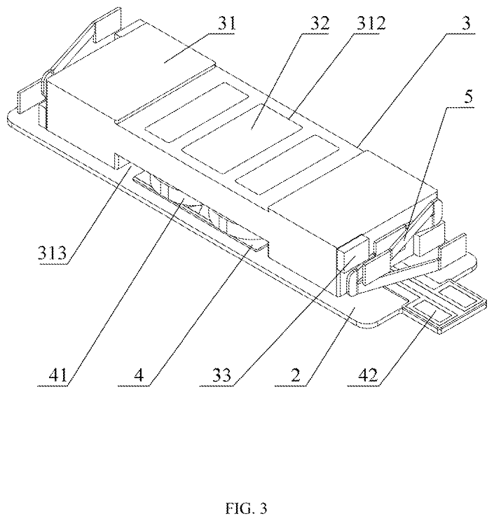

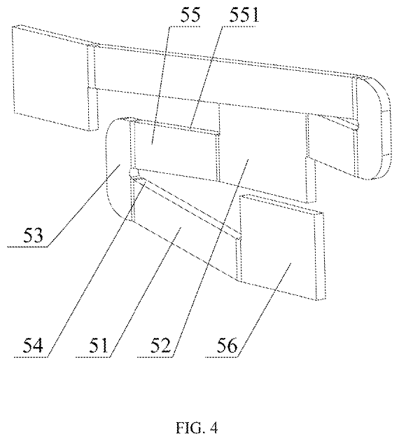

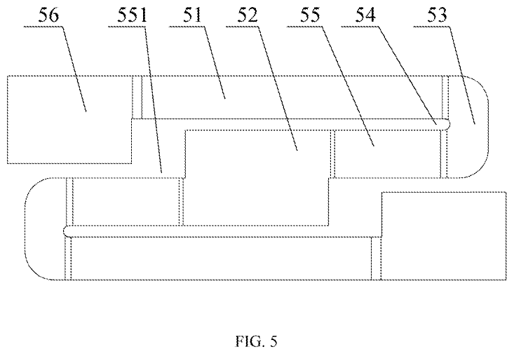

FIG. 1 is an exploded view of a linear vibration motor with S-shaped leaf springs, provided by an embodiment of the present disclosure; FIG. 2 is a sectional view of a linear vibration motor with S-shaped leaf springs, provided by the embodiment of the present disclosure; FIG. 3 is a schematic diagram of a three-dimensional structure of a linear vibration motor with S-shaped leaf springs with a housing removed, provided by the embodiment of the present disclosure; FIG. 4 is a schematic diagram of a three-dimensional structure of an S-shaped leaf spring provided by the embodiment of the present disclosure; and FIG. 5 is a front view of an S-shaped leaf spring provided by the embodiment of the present disclosure.

### Embodiment

As shown in FIG. 1 to FIG. 5, a linear vibration motor with S-shaped leaf springs includes an upper enclosure 1 and a lower enclosure 2, the upper enclosure 1 and the lower enclosure 2 are generally in welded connection, a mover assembly 3 and a stator assembly 4 correspondingly cooperating with the mover assembly 3 are disposed inside a space defined by the upper enclosure 1 and the lower enclosure 2, the stator assembly 4 is located below the mover assembly 3 and is fixedly disposed on the lower enclosure 2, and two ends, in an X direction, of the mover assembly 3 are elastically connected with the upper enclosure 1 by S-shaped leaf springs 5. Specifically, each S-shaped leaf spring 5 includes three layers, elastic arms 51 located on the upper layer and the lower layer are connected with the upper enclosure 1, a fixing part 52 located on the middle layer is connected with the mover assembly 3, the two elastic arms 51 are respectively connected with the fixing part 52 by first bent parts 53 generally by means of welding, and a first slot 54 is formed between each of the two elastic arms 51 and the fixing part 52.

In the present disclosure, the X direction and the Z direction are given, the X direction is the vibration direction of the mover assembly 3, the Z direction is the vertical direction, the direction vertical to the X direction and the Z direction is the Y direction, the X direction and the Y direction are longitudinal and transverse directions of a horizontal direction, and terms “upper”, “lower” and the like described herein are described with reference to the Z direction.

During use, the stator assembly 4 interacts with the mover assembly 3 so that the mover assembly 3 bears a certain acting force. The mover assembly 3 cooperates with the two S-shaped leaf springs 5 to vibrate in the X direction, so that the vibration of the motor is realized. Compared with the prior art, the present disclosure adopts the S-shaped leaf springs 5 which are simple in structure, convenient to machine, low in production cost, stable in elastic coefficient and relatively high in elasticity; the elastic arms 51 on the upper layer and the lower layer are connected with the upper enclosure 1, the fixing part 52 on the middle layer is connected with the mover assembly 3, in this way, three-point welded connection and symmetric distribution are formed, so that the connection stability and reliability are high, the mass production capability and the process yield of the leaf springs are improved, and it is ensured that a mass block 31 can stably vibrate; and due to the arrangement of the first bent parts 53 and the first slots 54, it is convenient to control the volumes of the leaf springs and improve the elasticity of the leaf springs, moreover, stresses of the leaf springs can be released to prevent the leaf springs from deforming, so that the structural stability is high, the service life is long, and furthermore, the vibration effect and stability of the motor are improved.

The two first bent parts 53 are respectively connected with the fixing part 52 by inclined parts 55, in this way, the inclined part 55 is equivalent to a part of the elastic arm 51, that is, the inclined part 55, the first bent part 53 and the elastic arm 51 form an elastic part, so that the elastic coefficient is increased, and the elasticity is improved. Furthermore, the inclined parts 55 are provided with adjusting slots 551, and the sizes of the adjusting slots 551 are set according to a demand of a user for the specific vibration of the motor, so that it is convenient to control the widths of the elastic arms 51, and furthermore, the elastic coefficient and the frequencies of the leaf springs are adjusted, wherein the larger the adjusting slots 551 are, the smaller the elastic coefficient and the frequencies are.

The ends, far away from the first bent parts 53, of the elastic arms 51 are provided with first widened parts 56 connected with the upper enclosure 1, so that it is convenient to realize welded connection between each of the S-shaped leaf springs 5 and the upper enclosure 1, and the strength is high after connection. Furthermore, junctions of the first widened parts 56 and the elastic arms 51 are bent, and the first widened parts 56 are parallel to the inner wall of the upper enclosure 1 connected with the first widened parts 56, in this way, it is more convenient to realize welded connection between each of the S-shaped leaf springs 5 and the upper enclosure 1, moreover, it is convenient to control the volumes of the leaf springs and improve the elasticity of the leaf springs, and higher stability and reliability are achieved. In addition, the first widened parts 56 may further correspond to the adjusting slots 551, and thus, the adjusting slots 551 can also play an avoiding role and are more compact in structure.

The mover assembly 3 includes a mass block 31, the mass block 31 is also called a balance weight, a vibration block, a clump weight and the like, the mass block 31 is provided with three or more permanent magnets 32 arranged in the X direction, the permanent magnets 32 are magnetized in the Z direction, and magnetization directions of the adjacent permanent magnets 32 are opposite. The stator assembly 4 includes two or more coils 41 arranged in the X direction, current directions of the adjacent coils 41 are opposite, the coils 41 are one less than the permanent magnets 32, the ends, far away from the adjacent coils 41, of the coils 41 at the outer side correspond to one of the permanent magnets 32, the coils 41 at the outer side are the coils 41 at two ends in the X direction, the ends, close to each other, of the adjacent coils 41 correspond to the same permanent magnet 32, so that directions of ampere forces acting on all the coils 41 can be the same, in this way, directions of counter-acting forces acting on all the permanent magnets 32 are also the same, the mover assembly 3 can better vibrate in the X direction, and higher stability and reliability are achieved; and the coils 41 may be connected with an external circuit by a flexible circuit board 42, the flexible circuit board 42 is fixedly disposed on the lower enclosure 2, and the number of the coils 41 and the number of the permanent magnets 32 are determined according to the size of the motor. During use, the external circuit supplies power for the coils 41 by virtue of the flexible circuit board 42, the electrified coils 41 bear the ampere forces in magnetic fields generated by the permanent magnets 32; since the coils 41 are fixed, the permanent magnets 32 bear corresponding counter-acting forces, and thus, the mover assembly 3 vibrates in the X direction to realize the vibration of the motor; moreover, the vibration frequency and amplitude of the mover assembly 3 can be changed by adjusting current waveforms of the coils 41, so that different vibration sensations can be generated; various different tactile feedbacks are achieved due to the abundant vibration sensations; it is convenient to apply the motor to a power source for tactile feedback of an intelligent device, and thus, the application range of the motor is widened. In addition, the widths, in the X direction, of the permanent magnets 32 at the outer side are half of the widths, in the X direction, of other permanent magnets 32, the permanent magnets 32 at the outer side are the permanent magnets 32 located at two ends in the X direction, and thus, it is ensured that magnetic fields acting on two ends of each of the coils 41 are the same.

In addition, it should be explained that the flexible circuit board 42, i.e., a Flexible Printed Circuit, FPC for short, is a printed circuit board made of polyimide or polyester film serving as a base material and having high reliability and superexcellent flexibility, and has the characteristics of high wiring density, light weight, small thickness and good bending property. The permanent magnets 32 refer to magnets capable of keeping relatively high residual magnetism for a long term in an open-circuit state and are also called hard magnets such as permanent magnets made of a ferrite permanent magnet material or magnetic steel, preferably, the magnetic steel which has the characteristics such as high hardness, high coercive force value, high temperature resistance and corrosion resistance, has relatively good permanent magnet property and can still keep relatively strong and stable magnetism for a long term after saturation magnetization is performed thereon and an external magnetic field is removed.

The mass block 31 is suspended in the upper enclosure 1 by the two S-shaped leaf springs 5, and the middle parts of the two ends, in the X direction, of the mass block 31 are each provided with a positioning part 311 connected with the fixing part 52, the positioning parts 311 may be slots or bulges matched with the fixing parts 52 of the S-shaped leaf springs 5, and thus, the connection precision of the S-shaped leaf springs 5 and the mass block 31 can be improved. Moreover, connection points are located in the middles of the mass block 31, so that the offset of the mass block 31 in the X direction during vibration can be reduced.

The mass block 31 is provided with first through holes 312 matched with the permanent magnets 32, the number of the first through holes 312 is the same as that of the permanent magnets 32, the permanent magnets 32 are mounted in the first through holes 312 generally by means of gluing, and therefore, convenience in assembly, compact structure and good stability are achieved.

The bottom of the mass block 31 is provided with an avoiding slot 313 matched with the coils 41, and the avoiding slot 313 communicates with the first through holes 312, all the coils 41 are located in the avoiding slot 313 all the time during vibration of the mass block 31, and therefore, more compact structure as well as better stability and reliability are achieved.

The two ends, in the X direction, of the mass block 31 are each provided with two limiting buffer blocks 33, and two limiting buffer blocks 33 correspondingly cooperate with two elastic arms 51. Generally, the limiting buffer blocks 33, the first widened parts 56 and the adjusting slots 551 correspond to one another, during the vibration of the mass block 31, the limiting buffer blocks 33 can prevent the mass block 31 from being in direct contact with the elastic arms 51 of the S-shaped leaf springs 5 to play a buffer protection role, so that higher safety and reliability are achieved. Furthermore, the two ends, in the X direction, of the mass block 31 are respectively provided with slots for mounting the limiting buffer blocks 33, the two limiting buffer blocks 33 are generally glued in the slots, and thus, firmer connection and higher stability and reliability are achieved. In addition, the limiting buffer blocks 33 are made of rubber, polyurethane or foam, wherein the rubber has the advantages such as good elasticity, high strength and low price, the polyurethane has the advantages such as relatively high flexibility, resilience, mechanical strength and oxidation stability and excellent oil resistance, and the foam has the advantages such as elasticity, light weight, rapid pressure sensitive fixation, convenience in use, bendability, ultrathin size and reliable properties.

The above descriptions are only some implementation manners of the present disclosure and are only intended to describe the technical solutions of the present disclosure, rather than to limit the present disclosure. It should be understood that improvements or replacements may be further made by those of ordinary skill in the art according to the above-mentioned description without departing from the creative concept of the present disclosure, and all these improvements and replacements should fall within the protective range of the appended claims of the present disclosure. In this case, all details can be replaced with equivalent elements, and materials, shapes and sizes may also be arbitrary.

What is claimed is:

1. A linear vibration motor with S-shaped leaf springs, comprising an upper enclosure and a lower enclosure, wherein
a mover assembly and a stator assembly, wherein the stator assembly is correspondingly cooperating with the mover assembly, are disposed in a space defined by the upper enclosure and the lower enclosure, the stator assembly is located below the mover assembly and the stator assembly is fixedly disposed on the lower enclosure, and two ends, in an X direction, of the mover assembly are elastically connected to the upper enclosure by the S-shaped leaf springs; and
each S-shaped leaf spring comprises two elastic arms located on an upper layer and a lower layer and the two elastic arms are connected to the upper enclosure and a fixing part located on a middle layer and the fixing part connected to the mover assembly, the two elastic arms are respectively connected to the fixing part by two first bent parts, and a first slot is formed between each of the two elastic arms and the fixing part.

2. The linear vibration motor with the S-shaped leaf springs according to claim 1, wherein the two first bent parts are respectively connected to the fixing part by inclined parts.

3. The linear vibration motor with the S-shaped leaf springs according to claim 2, wherein the inclined parts are provided with adjusting slots.

4. The linear vibration motor with the S-shaped leaf springs according to claim 1, wherein ends, far away from the two first bent parts, of the two elastic arms are provided with first widened parts connected to the upper enclosure.

5. The linear vibration motor with the S-shaped leaf springs according to claim 4, wherein junctions of the first widened parts and the two elastic arms are bent, and the first widened parts are parallel to an inner wall of the upper enclosure connected to the first widened parts.

6. The linear vibration motor with the S-shaped leaf springs according to claim 1, wherein the mover assembly comprises a mass block, wherein
the mass block is provided with three or more permanent magnets arranged in the X direction, the three or more permanent magnets are magnetized in a Z direction, and magnetization directions of adjacent permanent magnets are opposite; and
the stator assembly comprises two or more coils arranged in the X direction, current directions of adjacent coils are opposite, the two or more coils are one less than the three or more permanent magnets, ends, far away from the adjacent coils, of the two or more coils at an outer side correspond to one of the three or more permanent magnets, ends, close to each other, of the adjacent coils correspond to a same permanent magnet, and the two or more coils are connected to an external circuit by a flexible circuit board fixedly disposed on the lower enclosure.

7. The linear vibration motor with the S-shaped leaf springs according to claim 6, wherein the mass block is suspended in the upper enclosure by the S-shaped leaf springs, and middle parts of two ends, in the X direction, of the mass block are each provided with a positioning part connected to the fixing part.

8. The linear vibration motor with the S-shaped leaf springs according to claim 6, wherein the mass block is provided with a plurality of first through holes matched with the three or more permanent magnets.

9. The linear vibration motor with the S-shaped leaf springs according to claim 8, wherein a bottom of the mass block is provided with an avoiding slot matched with the two or more coils, and the avoiding slot communicates with the plurality of first through holes.

10. The linear vibration motor with the S-shaped leaf springs according to claim 6, wherein two ends, in the X direction, of the mass block are each provided with two limiting buffer blocks, and the two limiting buffer blocks correspondingly cooperate with the two elastic arms.

11. The linear vibration motor with the S-shaped leaf springs according to claim 2, wherein the mover assembly comprises a mass block, wherein
the mass block is provided with three or more permanent magnets arranged in the X direction, the three or more permanent magnets are magnetized in a Z direction, and magnetization directions of adjacent permanent magnets are opposite; and
the stator assembly comprises two or more coils arranged in the X direction, current directions of adjacent coils are opposite, the two or more coils are one less than the three or more permanent magnets, ends, facing away from the adjacent coils, of the two or more coils at an outer side correspond to one of the three or more permanent magnets, ends, facing each other, of the adjacent coils correspond to a same permanent magnet, and the two or more coils are connected to an external circuit by a flexible circuit board fixedly disposed on the lower enclosure.

12. The linear vibration motor with the S-shaped leaf springs according to claim 3, wherein the mover assembly comprises a mass block, wherein
the mass block is provided with three or more permanent magnets arranged in the X direction, the three or more permanent magnets are magnetized in a Z direction, and magnetization directions of adjacent permanent magnets are opposite; and
the stator assembly comprises two or more coils arranged in the X direction, current directions of adjacent coils are opposite, the two or more coils are one less than the three or more permanent magnets, ends, facing away from the adjacent coils, of the two or more coils at an outer side correspond to one of the three or more permanent magnets, ends, facing each other, of the adjacent coils correspond to a same permanent magnet, and the two or more coils are connected to an external circuit by a flexible circuit board fixedly disposed on the lower enclosure.

13. The linear vibration motor with the S-shaped leaf springs according to claim 4, wherein the mover assembly comprises a mass block, wherein
the mass block is provided with three or more permanent magnets arranged in the X direction, the three or more permanent magnets are magnetized in a Z direction, and magnetization directions of adjacent permanent magnets are opposite; and
the stator assembly comprises two or more coils arranged in the X direction, current directions of adjacent coils are opposite, the two or more coils are one less than the three or more permanent magnets, ends, facing away from the adjacent coils, of the two or more coils at an outer side correspond to one of the three or more permanent magnets, ends, facing each other, of the adjacent coils correspond to a same permanent magnet, and the two or more coils are connected to an external circuit by a flexible circuit board fixedly disposed on the lower enclosure.

14. The linear vibration motor with the S-shaped leaf springs according to claim 5, wherein the mover assembly comprises a mass block, wherein
the mass block is provided with three or more permanent magnets arranged in the X direction, the three or more permanent magnets are magnetized in a Z direction, and magnetization directions of adjacent permanent magnets are opposite; and
the stator assembly comprises two or more coils arranged in the X direction, current directions of adjacent coils are opposite, the two or more coils are one less than the three or more permanent magnets, ends, facing away from the adjacent coils, of the two or more coils at an outer side correspond to one of the three or more permanent magnets, ends, facing each other, of the adjacent coils correspond to a same permanent magnet, and the two or more coils are connected to an external circuit by a flexible circuit board fixedly disposed on the lower enclosure.

15. The linear vibration motor with the S-shaped leaf springs according to claim 11, wherein the mass block is suspended in the upper enclosure by the S-shaped leaf springs, and middle parts of two ends, in the X direction, of the mass block are each provided with a positioning part connected to the fixing part.

16. The linear vibration motor with the S-shaped leaf springs according to claim 12, wherein the mass block is suspended in the upper enclosure by the S-shaped leaf springs, and middle parts of two ends, in the X direction, of the mass block are each provided with a positioning part connected to the fixing part.

17. The linear vibration motor with the S-shaped leaf springs according to claim 13, wherein the mass block is suspended in the upper enclosure by the S-shaped leaf springs, and middle parts of two ends, in the X direction, of the mass block are each provided with a positioning part connected to the fixing part.

18. The linear vibration motor with the S-shaped leaf springs according to claim 14, wherein the mass block is suspended in the upper enclosure by the S-shaped leaf springs, and middle parts of two ends, in the X direction, of the mass block are each provided with a positioning part connected to the fixing part.

19. The linear vibration motor with the S-shaped leaf springs according to claim 11, wherein the mass block is provided with a plurality of first through holes matched with the three or more permanent magnets.

20. The linear vibration motor with the S-shaped leaf springs according to claim 12, wherein the mass block is provided with a plurality of first through holes matched with the three or more permanent magnets.
